(19) United States
(12) Patent Application Publication
(10) Pub. No.: US 2010/0121696 A1
(43) Pub. Date: May 13, 2010

(54) SYSTEM AND METHOD FOR PROVIDING CUSTOMERS ACCESS TO INCENTIVE DEALS

(76) Inventors: Daniel James Green, Henderson, NV (US); Stephanie Amanda Loosvelt, Henderson, NV (US)

Correspondence Address: DUANE MORRIS LLP - Philadelphia;IP DEPARTMENT, 30 SOUTH 17TH STREET, PHILADELPHIA, PA, 19103-4196, US

(21) Appl. No.: 12/466,539

(22) Filed: May 15, 2009

Related U.S. Application Data
(60) Provisional application No. 61/053,882, filed on May 16, 2008.

(51) Int. Cl. G06Q 30/00; G06Q 10/00; G06F 17/30; G06F 3/048

(52) U.S. Cl. 705/14.13; 705/14.25; 707/769; 715/739

(57) ABSTRACT

A computer-implemented method of provides customers access to incentive deals. The method includes maintaining a database of customer prospect accounts associated with customer prospects. Each of the customer prospect accounts includes customer data associated with the customer prospect. A plurality of incentive deals are registered in an incentive deal database. Each incentive deal is associated with incentive deal identifying data and predetermined customer prospect eligibility criteria. The customer data is traversed against the predetermined customer prospect eligibility criteria. A description of one or more incentive deals for which the customer prospect is eligible are identified to the customer prospect on a user terminal based on results of the traversing step.

### CROSS-REFERENCE TO RELATED APPLICATIONS

This application claims priority to U.S. Provisional Patent Application No. 61/053,882 filed May 16, 2008 and entitled “System and Method for Providing Customers Access to Incentive Deals”, the entirety of which is hereby incorporated by reference herein.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to sales and marketing, and more particularly to systems and methods for sales and marketing for incentive deals.

### BACKGROUND OF THE INVENTION

Timeshare companies as well as other sellers of leisure, tourism, and vacation real estate products typically offer handsome incentives to prospective buyers in return for participating in a sales presentation. These incentives can range from gifts of money, show tickets, dining vouchers, and vacation tours to complimentary accommodations. The leisure and real estate industry as a whole spends hundreds of millions of dollars each year promoting their properties. With the changing economy, rising fuel prices, and the threat of terror, marketing costs continue to rise, resulting in decreased profits and increased product price. This in turn raises the retail price and alienates a large sector of the population that would otherwise fit within the normal profile of a timeshare, fractional share, or second homebuyer.

Moreover, commissions to marketing agents, the costs related to telemarketing, and problems associated with “Do Not Call” lists have hurt the profitability of companies in this sector. These costs are passed onto the consumer, which in turn means that the targeted client has to change. For example, a prospect that has a household income of $40,000 and could still comfortably afford to purchase a timeshare at $15,000 now has to earn $60,000 because the price for the timeshare is now $25,000 due to the increased marketing costs. There is no sign that this trend is slowing down.

An improved system for providing prospects access to incentive deals is desirable.

### SUMMARY OF THE INVENTION

In some embodiments, a computer-implemented method provides customers access to incentive deals. The method includes maintaining a database of customer prospect accounts associated with customer prospects. Each of the customer prospect accounts includes customer data associated with the customer prospect. A plurality of incentive deals are registered in an incentive deal database. Each incentive deal is associated with incentive deal identifying data and predetermined customer prospect eligibility criteria. The customer data is traversed against the predetermined customer prospect eligibility criteria. A description of one or more incentive deals for which the customer prospect is eligible based on results of the traversing step are identified to the customer prospect on a user terminal.

The above and other features of the present invention will be better understood from the following detailed description of the preferred embodiments of the invention that is provided in connection with the accompanying drawings.

### BRIEF DESCRIPTION OF THE DRAWINGS

The accompanying drawings illustrate preferred embodiments of the invention, as well as other information pertinent to the disclosure, in which:

FIG. 1 is a stylized overview of an incentive access system connected to a plurality of interconnected computer networks;

FIGS. 2A-2D are examples of GUIs that may be presented to a consumer user by an incentive access system in accordance with FIG. 1;

FIGS. 3A-3B are examples of GUIs that may be presented to a manager of an incentive access system in accordance with FIG. 1;

FIGS. 4A-4H are examples of GUIs that may be presented to an incentive provider user by an incentive access system in accordance with FIG. 1;

FIG. 5 is a flow diagram of one example of a method performed by an incentive access system in accordance with FIG. 1; and

FIG. 6 is a flow diagram of one example of another method performed by an incentive access system in accordance with FIG. 1.

### DETAILED DESCRIPTION

This description of the exemplary embodiments is intended to be read in connection with the accompanying drawings, which are to be considered part of the entire written description.

A computer-based system and method that provide potential customers access to numerous incentive deals offered by incentive providers based on customer profiles that may be developed over time are described below. At the same time, the computer-based system and method enable incentive providers to target specific groups of potential customers. In exemplary embodiments, the method and system are web-based, as described below.

The Internet is a worldwide system of computer networks—a network of networks in which a user at one computer or other device connected to the network can obtain information from any other computer and communicate with users of other computers or devices. The most widely used part of the Internet is the World Wide Web (often-abbreviated “WWW” or called “the Web”).

One of the most outstanding features of the Web is its use of hypertext, which is a method of cross-referencing. In most Web sites, certain words or phrases appear in text of a different color than the surrounding text. This text is often also underlined. Sometimes, there are hot spots, such as buttons, images, or portions of images that are “clickable.” Clicking on hypertext or a hot spot causes the downloading of another web page via a protocol such as hypertext transport protocol (HTTP). Using the Web provides access to millions of pages of information. Web “surfing” is done with a Web browser, the most popular of which presently are Apple Safari and Microsoft Internet Explorer. The appearance of a particular website may vary slightly depending on the particular browser used. Versions of browsers have “plug-ins,” which provide animation, virtual reality, sound, and music. Interpreted programs (e.g., applets) may be run within the browser.

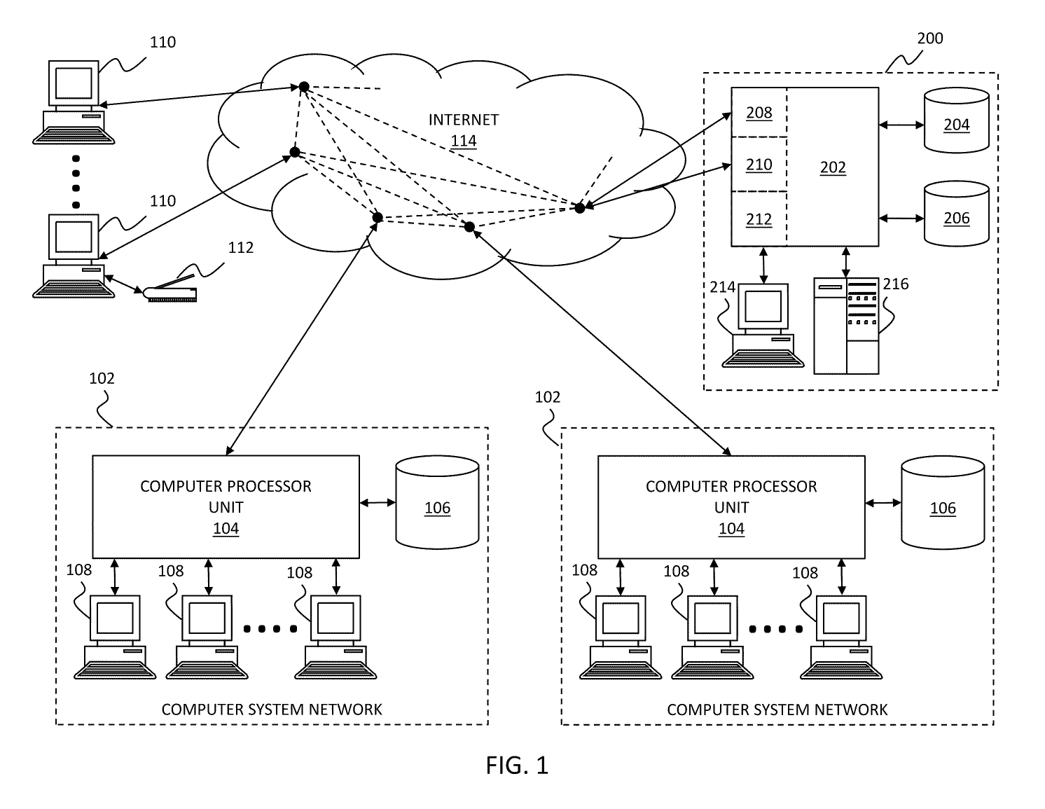

FIG. 1 shows an incentive access system 200 connected to a plurality of interconnected computer system networks 102 and devices 110. Each computer system network 102 may include a corresponding local computer processor unit 104, which is coupled to a corresponding local data storage unit 106 and to local network user terminals 108. A computer system network 102 may be a local area network (LAN) or part of a wide area network (WAN), for example. The incentive access system 200 and local computer processor units 104 are selectively coupled to a plurality of user devices 110 through Internet 114. Each of the plurality of user devices 110 and local user terminals 108 (collectively, user terminals) may have various devices connected to their local computer systems, such as scanners, barcode readers, printers, finger print scanners, mouse devices, keyboards, and other interface devices 112.

Incentive access system 200 includes a processing unit 202 coupled to one or more data storage units 204, 206. The processor unit 202 provides front-end graphical user interfaces (GUI), e.g., consumer GUI 208 and incentive provider GUI 210, as well as back-end GUIs 212 to a user's terminal 108, 110 or to local computer 214. The GUIs can take the form of, for example, a webpage that is displayed using a browser program local to the user terminal 108, 110, or to local computer 214. It is understood that incentive access system may be implemented on one or more computers 214, servers 216, or like devices. Front- and back-end GUIs 208, 210, 212 are preferably portal pages that includes various content retrieved from the one or more data storage devices 204, 206. As used herein, “portal” is not limited to general-purpose Internet portals, such as YAHOO! or GOOGLE but also includes GUIs that are of interest to specific, limited audiences and that provide the user access to a plurality of different kinds of related or unrelated information, links and tools as described below.

A user may gain access to incentive access system 200 by using a user device 108, 110, 214, programmed with a Web browser or other software, to locate and select (such as by clicking with a mouse) a particular webpage. The content of the webpage is located on the one or more data storage devices 204, 206. The user devices 108, 110 may be microprocessor-based computer terminals, pagers that can communicate through the Internet using the Internet Protocol (IP), Kiosks with Internet access, connected personal digital assistants or PDAs (e.g., a PALM device manufactured by Palm, Inc., IPAQ device available from Compaq, iPHONE from Apple or BLACKBERRY from RIM), or other devices capable of interactive network communications, such as an electronic personal planner. User devices 108, 110 may also be wireless devices, such as a hand-held unit (e.g., a cellular telephone or a portable music player such as an iPod) that connect to, and communicate through, the Internet using a wireless access protocol (WAP).

The system and method described herein may be implemented by utilizing at least a part of the system 200 described above in connection with FIG. 1. It should be apparent to one of ordinary skill in the art that the system may be incorporated in a LAN, in a WAN, or through an Internet 114 based approach, such as through a hosted or non-hosted application service, or through a combination thereof. The functionality of the method may be programmed and executed by at least one computer processor unit 202, with necessary data and graphical interface pages as described below stored in and retrieved from a data storage unit 204, 206. A user can access this functionality using a user device 108, 110.

As mentioned above, incentive access system 200 may provide separate features and functionality for front-end users, including consumer users and incentive provider users, as well as back-end users that manage the incentive access system 200. For the purposes of this document, a “consumer user” is an individual or organization that signs up for or otherwise takes advantage of an incentive, and an “incentive provider user” is an individual or organization that provides one or more incentives to consumer users. Accordingly, the consumer users are potential customers for the incentive providers.

Each consumer and incentive provider user is associated with a user profile that may be stored in a data storage device 204, 206. In some embodiments, consumer user profiles are stored in a consumer database 204 and incentive provider user profiles are stored in an incentive database 206. The user profile identifies how the portal user interface provided by computer processor unit 202 is to be personalized or customized for the respective user. Additionally, the user profile identifies what content from all available portal content should be included and not included in the user's customized or personalized portal user interface.

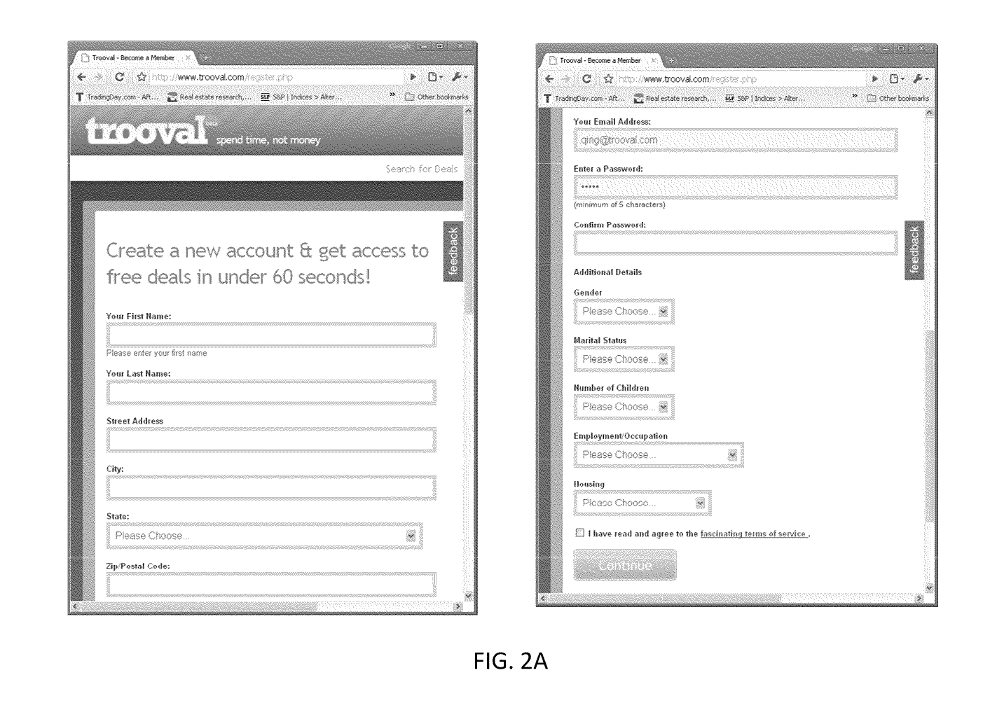

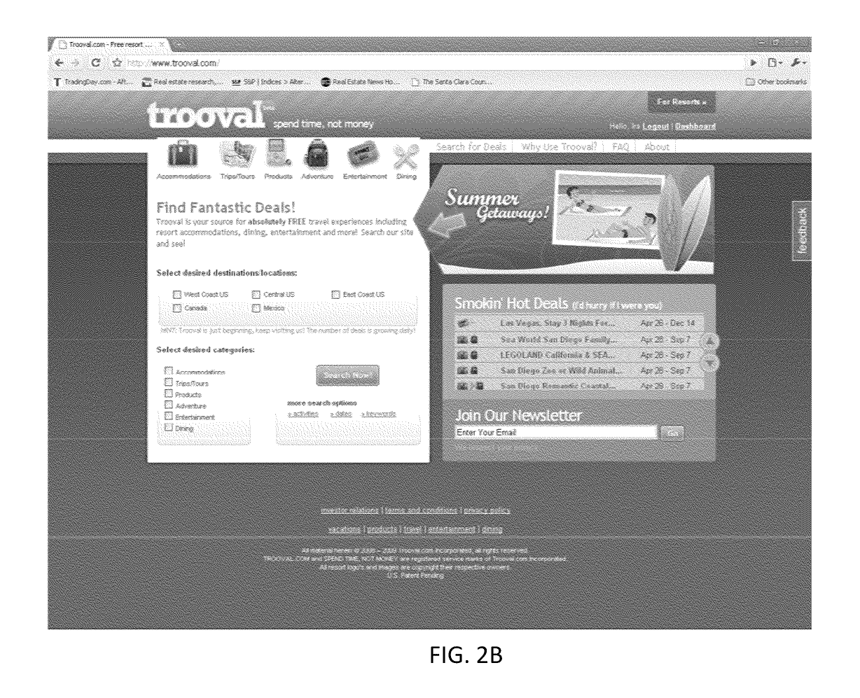

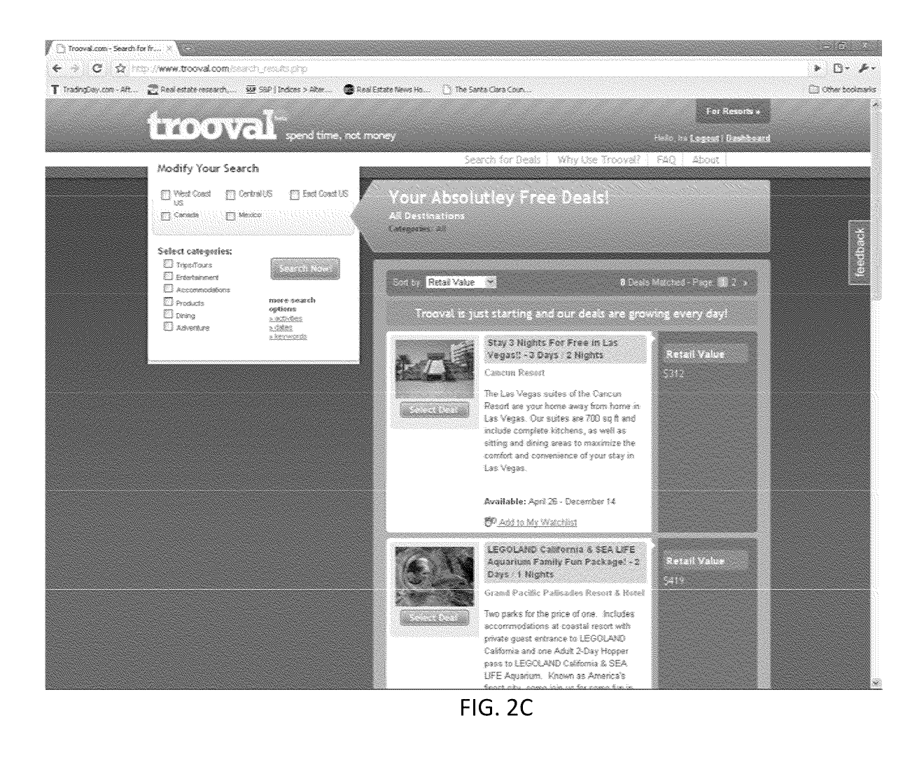

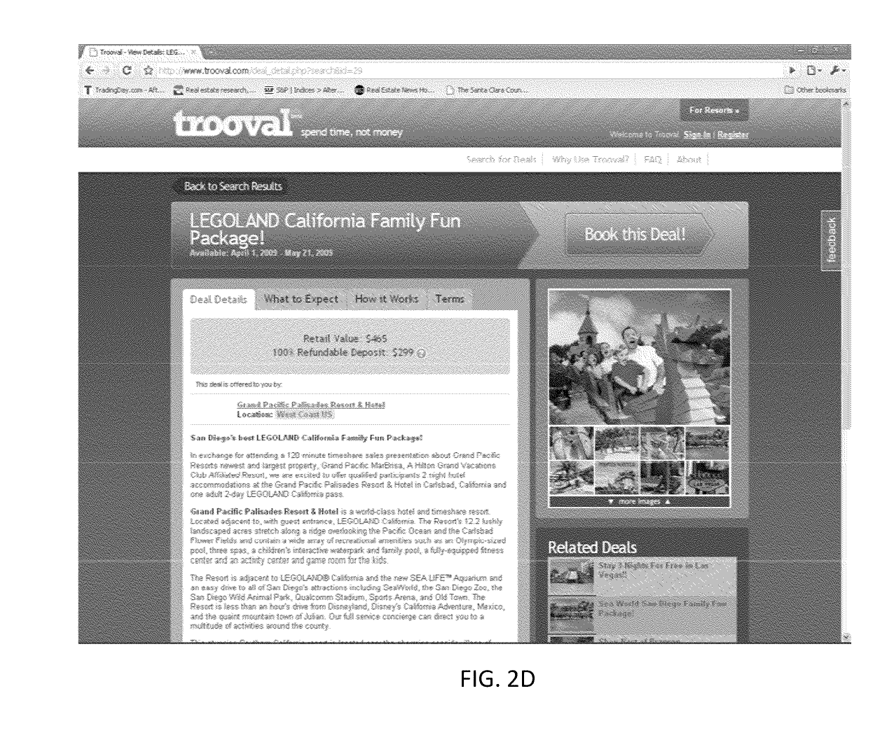

A consumer user initially registers an account with the incentive access system 200 to gain access to additional content provided by the incentive access system 200. The registration may include presentation of one or more GUIs as illustrated in FIG. 2A that require the consumer user to identify the consumer user's name, email address, and street address, as well as any of various demographic data such as age, gender, occupation, marital status, number of children and housing type. Additional consumer user information may also include a credit card number, type of credit card, travel frequency, and whether or not the consumer user owns a timeshare or vacation property. It will be understood that fewer or more fields may be required for registration of a consumer user. Incentive access system 200 retrieves other user data, such as household income, home value, length of residence, financial resources and ability to pay, in real-time via Internet from independent data sources, such as EquiFax and TargusInfo. Each consumer user enters a username and password to help protect the privacy of his or her profile, which is stored in consumer database 204.

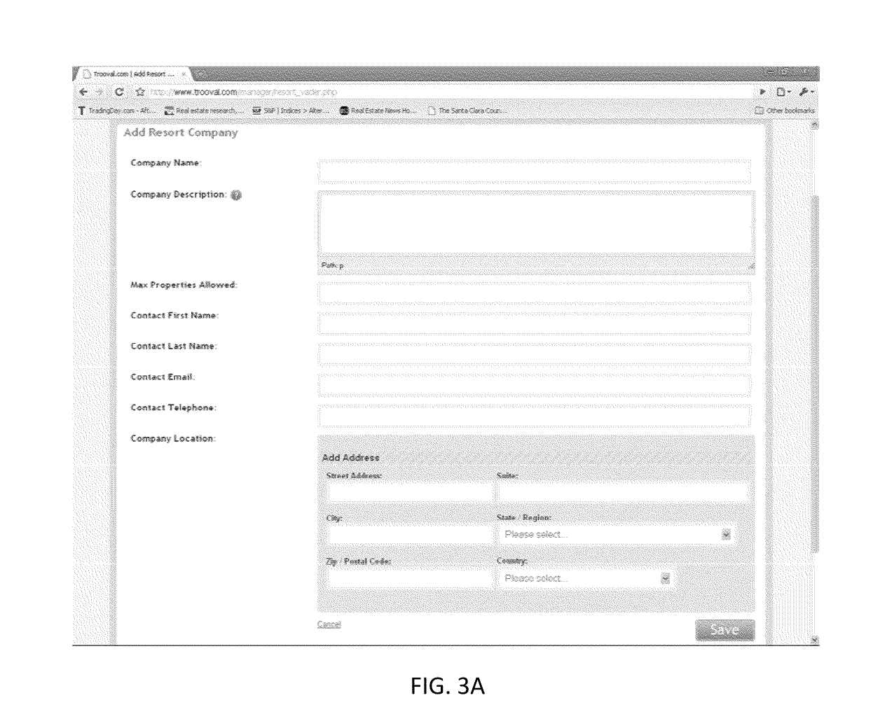

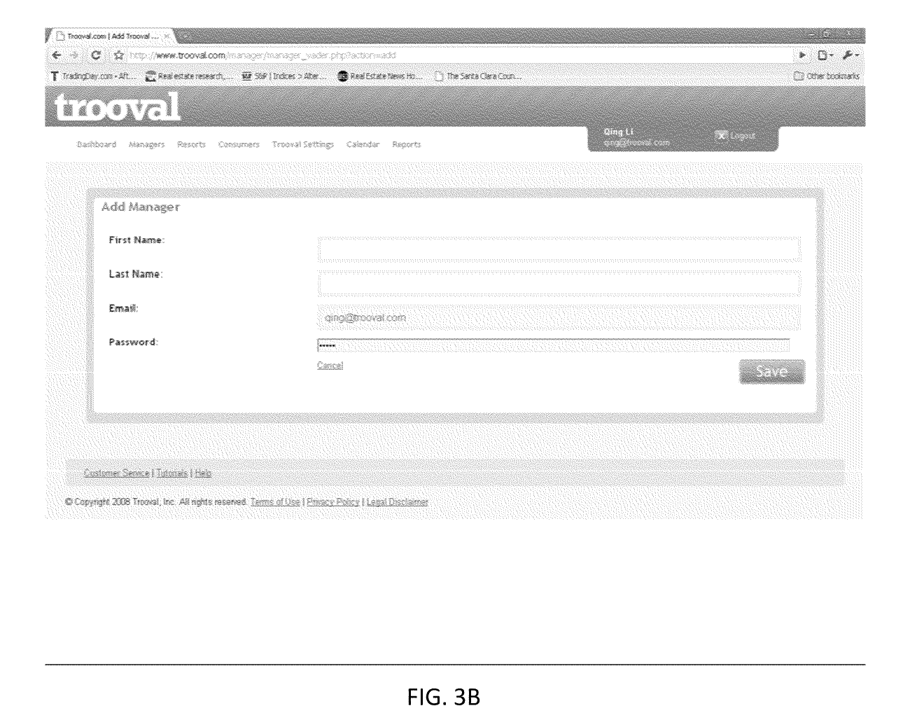

An incentive provider, e.g., a timeshare company, a hotel chain, restaurant, cruise operator, tour operator, golf course, amusement park, or other company or organization that provides incentive deals, also creates an account and provides access to the account to one or more incentive provider users. In some embodiments, the incentive provider may initially be registered by providing company information (e.g., the name address, and/or other identifying information) directly to the access system manager (or through an appropriately configured GUI) and upon payment of a fee to the manager of the incentive access system 200. The manager of the incentive access system 200 may then work to ensure that the incentive provider is a legitimate organization by acquiring or performing credit and/or background checks on the company or by performing other diligence. The manager of the incentive access system 200 may then enter the incentive provider's information in a GUI such as the one illustrated in FIG. 3A. As shown in FIG. 3A, a maximum number of properties that an incentive provider can register with the incentive access system 200 may be limited by the manager of the incentive provider system 200. In some embodiments, the number of properties an incentive provider can register is dependent upon the fee paid by the incentive provider. For example, an incentive provider paying $500 per month may be able to register ten properties (or products) with the incentive access system 200, and an incentive provider paying $1,000 per month may be able to register twenty properties (or products) with the incentive access system 200. Additionally, the manager of the incentive access system 200 may also create a profile for one or more managers for the incentive provider as illustrated in FIG. 3B.

In FIG. 3B, the “Dashboard” link allows the manager to view incentives, segments, and report summaries all in one screen. The “Manager” link presents a list of all the manager accounts. The “Resorts” link presents a listing of all resort accounts. The “Consumer” link presents a listing of all consumer user accounts. The “Settings” link presents a GUI that allows for the adding and editing of segment attributes (described below). The “Calendar” link provides a calendar view of scheduled incentives. Finally, the “Reports” link provides functionality for generating reports related to service providers, properties and incentive deals.

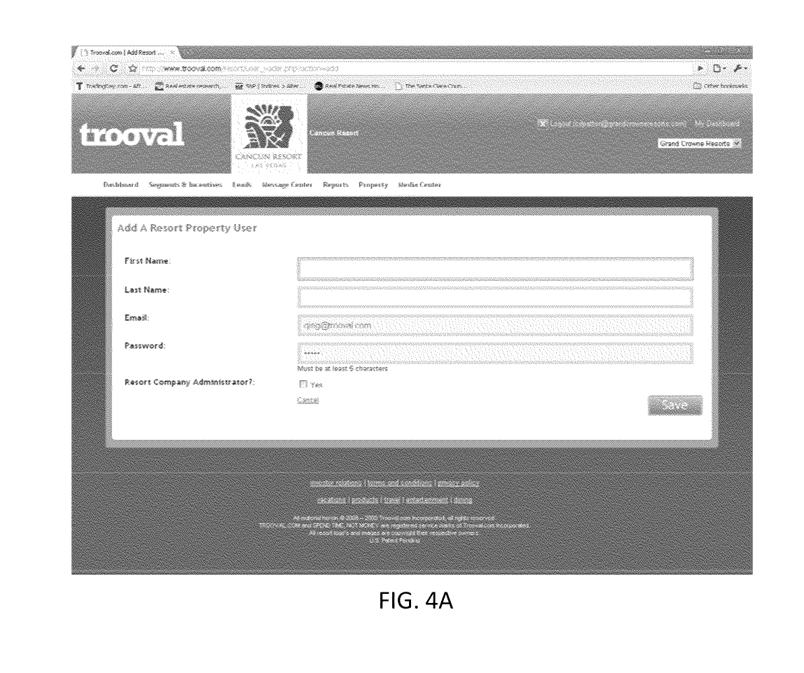

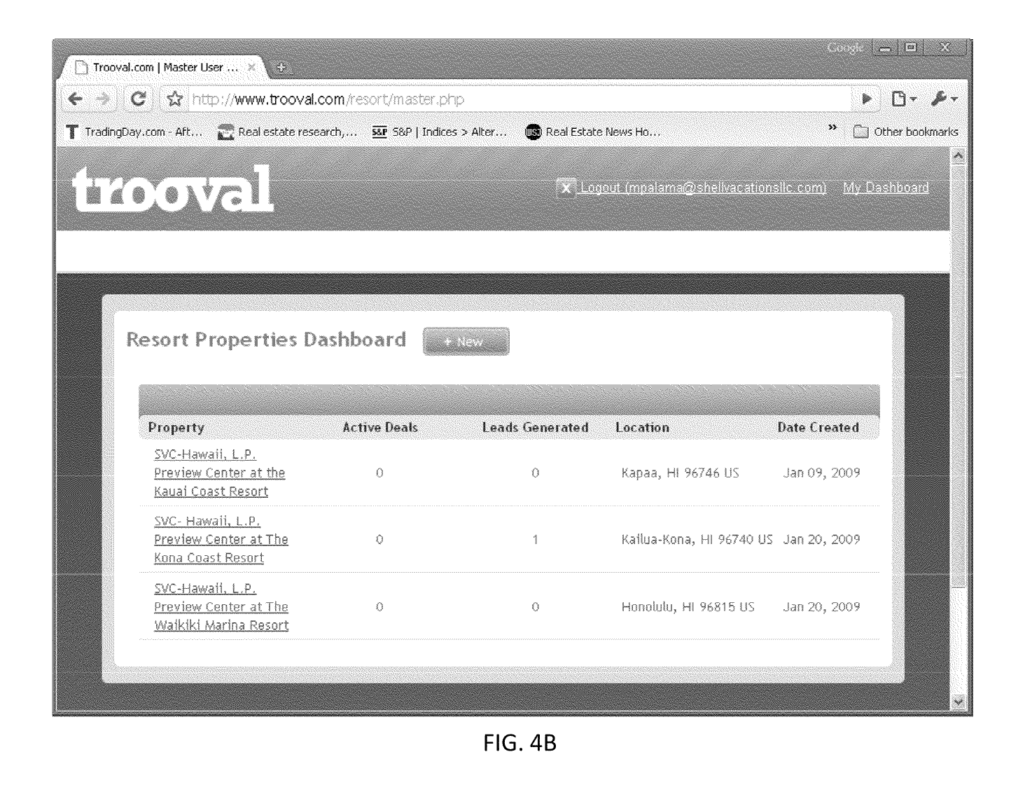

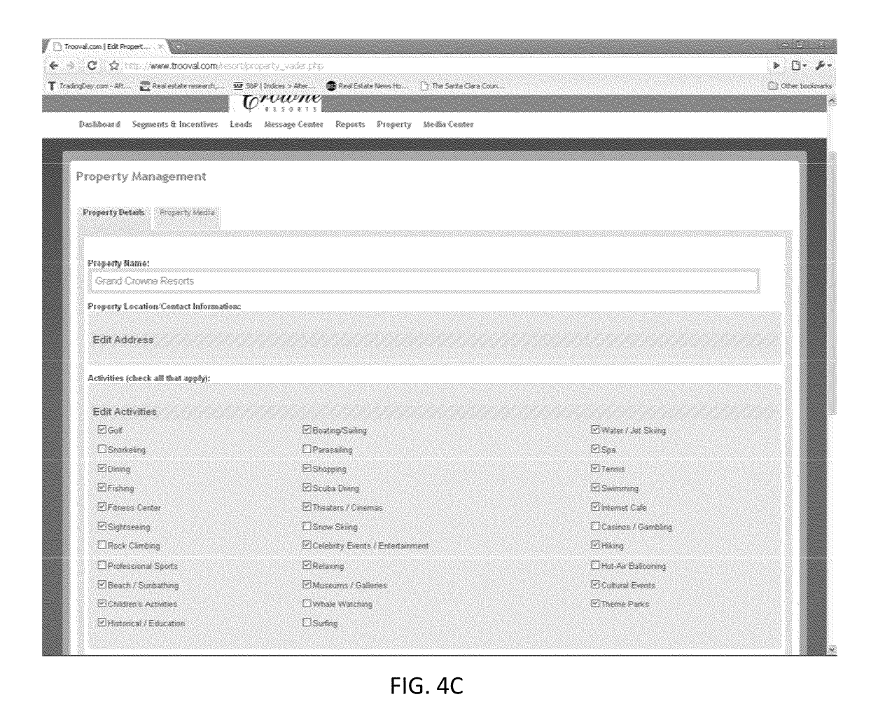

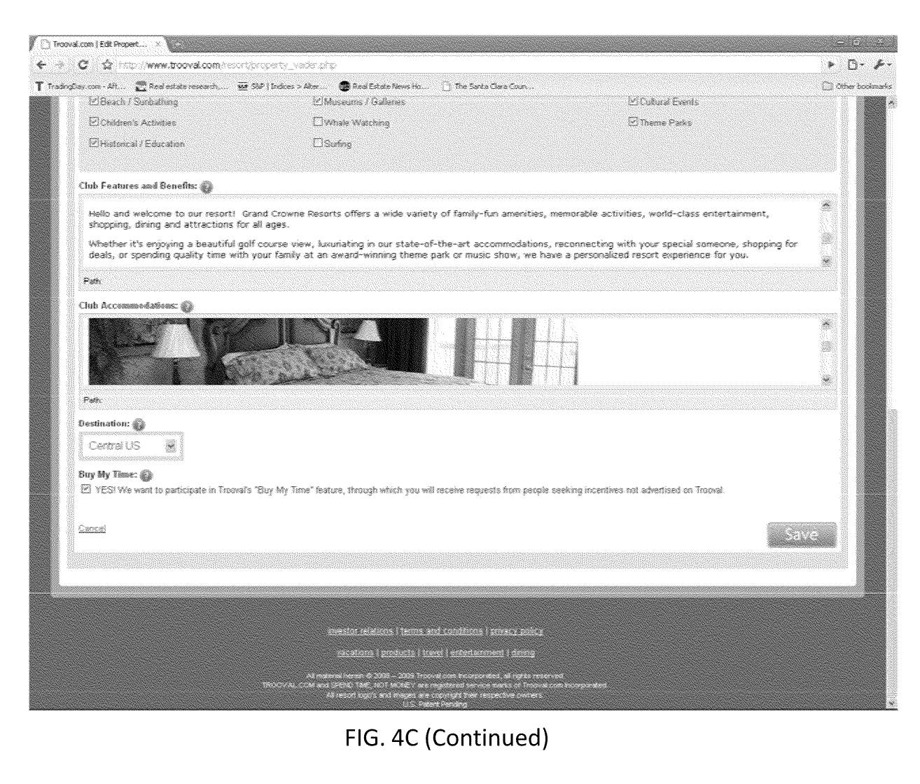

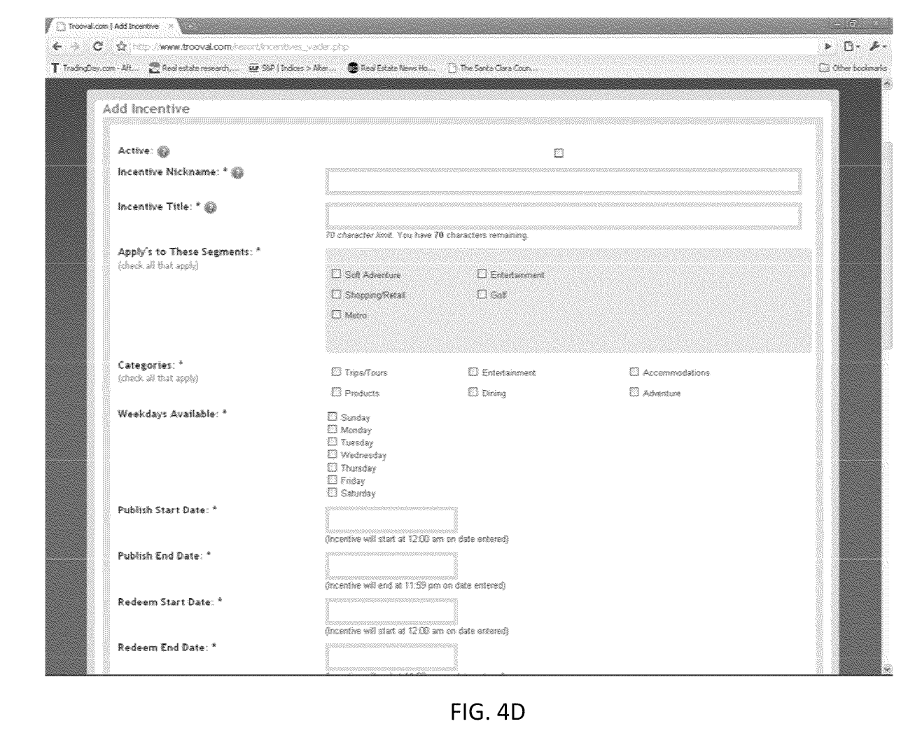

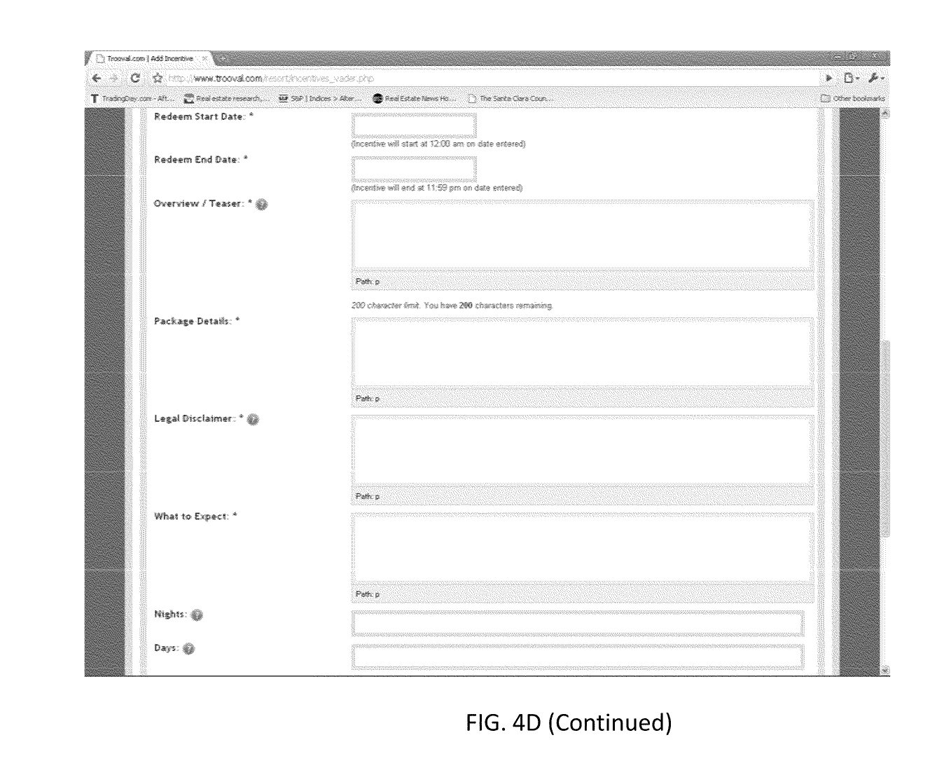

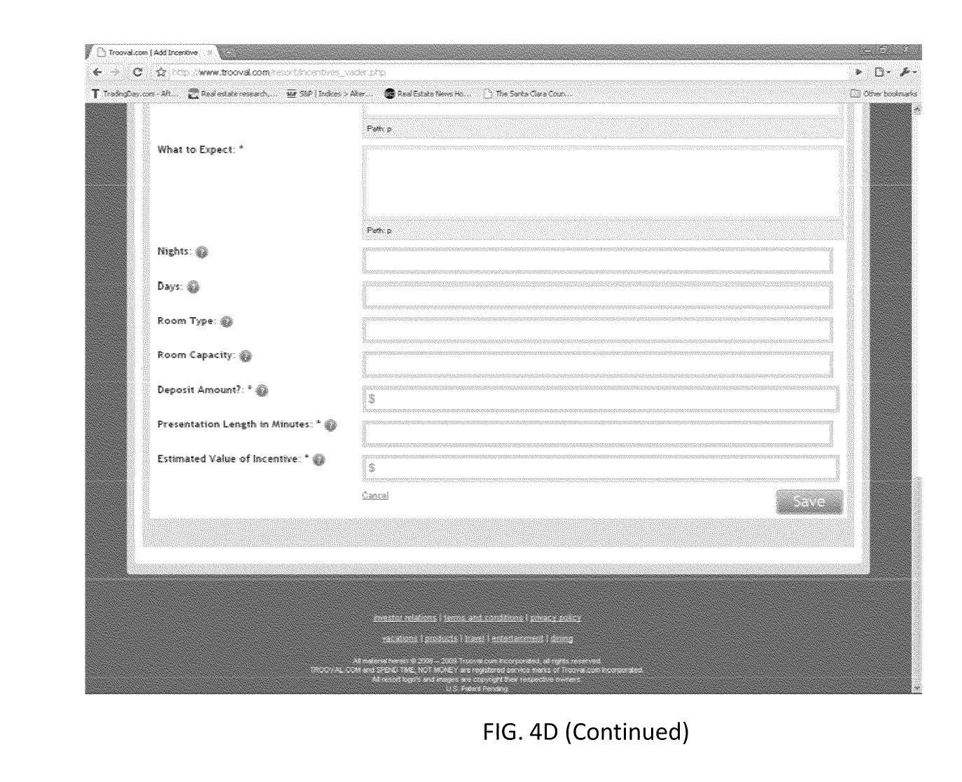

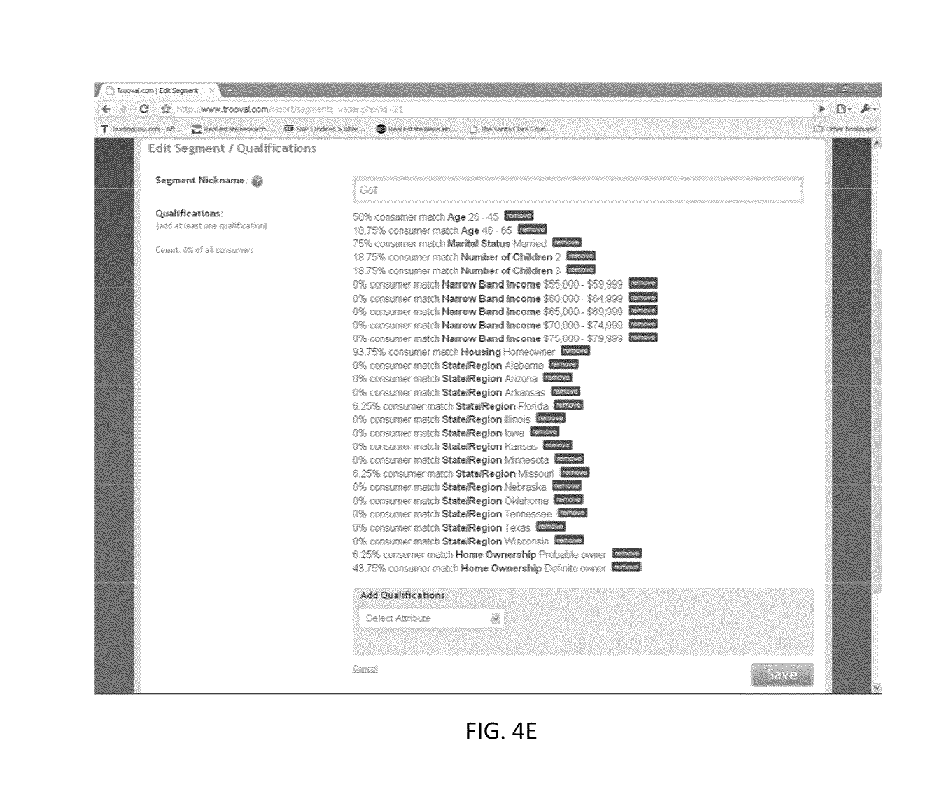

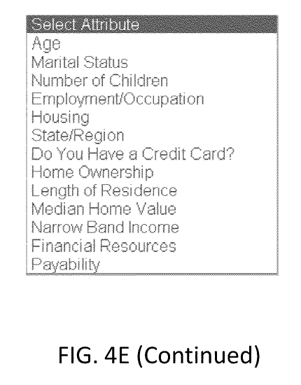

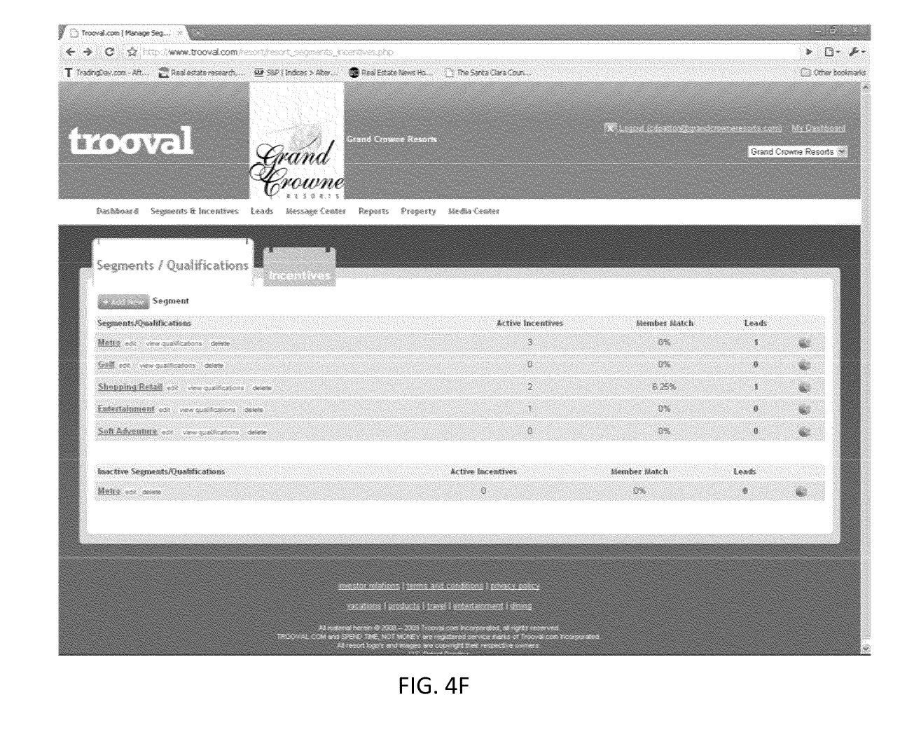

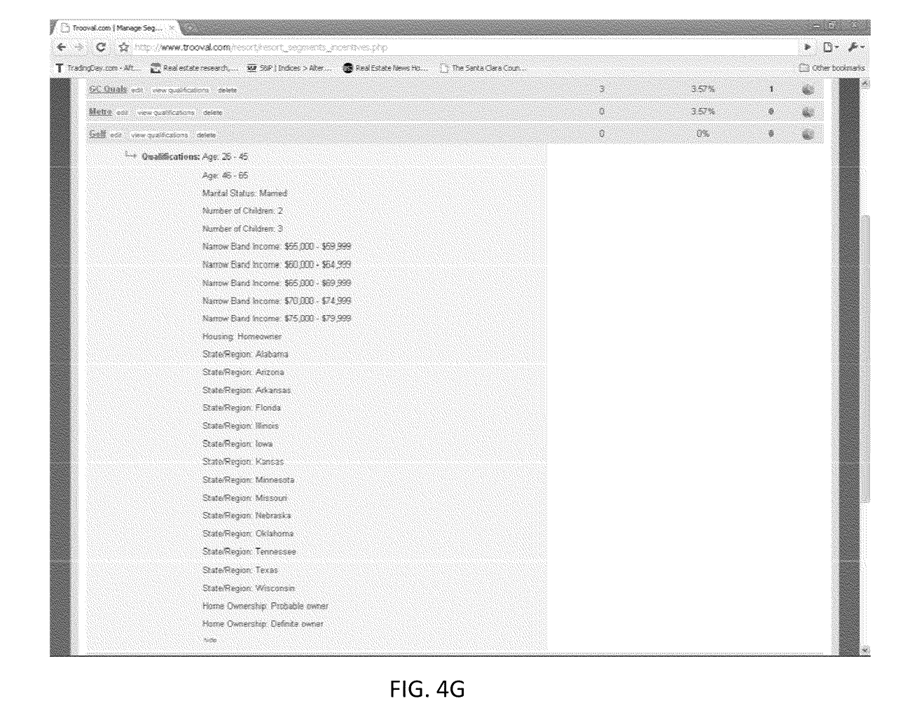

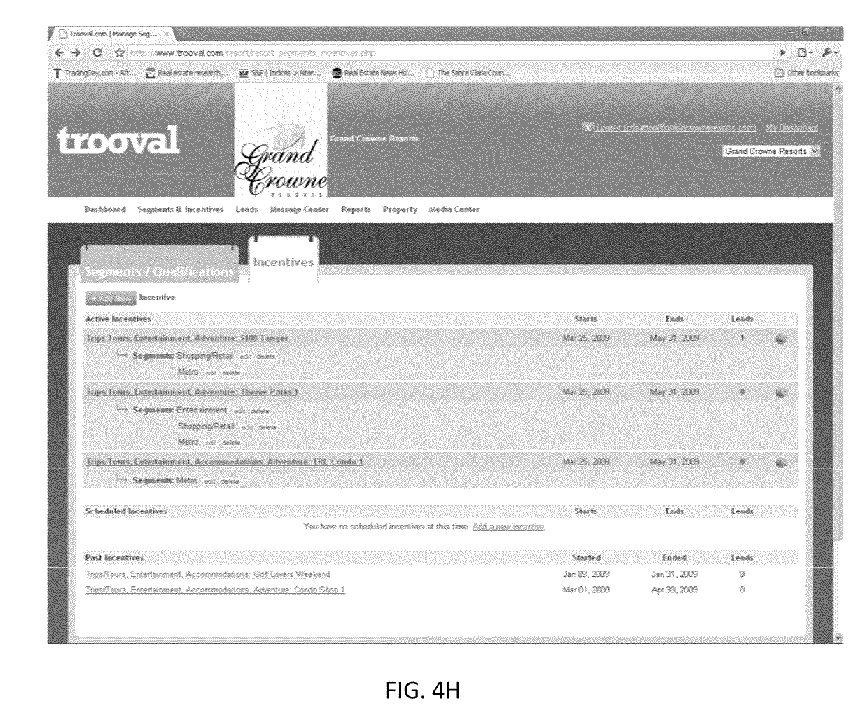

Once one or more managers for an incentive provider have been established in the incentive access system 200, these managers can add or set one or more incentive provider users that will be associated with the profile of the incentive provider as illustrated in FIG. 4A. As shown in FIG. 4A, the service provider master account user for the incentive service provider (e.g., resort) enters the name, email address, and grant administrative rights to each incentive provider user. One skilled in the art will understand that the GUI illustrated in FIG. 4A may be modified to enable additional data to be associated with each incentive provider user including, but not limited to, office location, home address, one or more telephone numbers, mobile device PIN, or the like.

Incentive access system 200 preferably provides each incentive provider user the ability review each property (or other product) of the incentive provider with which the incentive provider user is associated. FIG. 4B illustrates one example of a Resort Properties Dashboard GUI that may be accessed by an incentive provider user associated with a particular incentive provider. As shown in FIG. 4B, each incentive provider user may be permitted to delete and edit properties associated with the incentive provider by selecting (e.g., “clicking” on) the property name, or add a property by selecting “New.” These additions, deletions, or changes may be performed using a GUI as illustrated in FIG. 4C. As shown in FIG. 4C, an incentive provider user provides the property name and location, and select a number of pre-defined activities associated with, or available at, the property including, but not limited to, golfing, snorkeling, dining, fishing, boating, whale watching, tennis, theme parks, rock climbing, casinos, or the like. In addition, one or more user-fillable fields may be provided so that an incentive provider user can add additional narrative on activities or descriptions of the property that are not included in the pre-defined list. An incentive provider user may also be permitted to upload photographs, virtual tours, or videos of the property. The data for each of the properties may be stored in the incentive database 206.

The Dashboard of FIG. 4C also shows the number of “Active Deals” and “Leads Generated.” “Active Deals” represents the number of incentive deals that are currently available for that property. “Leads Generated” represents the number of consumers that have booked incentive deals for the property to date.

Incentive provider users can also add one or more incentive deals that are associated with each property and incentive provider. Incentive access system 200 advantageously enables incentive providers to target one or more particular preferred groups of consumer users based on a variety of criteria. FIG. 4D illustrates one example of a GUI for adding an incentive deal associated with a particular property or incentive provider. As shown in FIG. 4D, an incentive provider user may create an incentive deal and define a number “segments” to which the incentive may be targeted. That is, only consumer users that meet the criteria of the segments (either all selected segments or some defined subset) will be targeted by the system.

The segment names and underlying criteria for eligibility in the segment are user-definable by the incentive provider. In the alternative or in addition, segments can be selected from a library of predefined segments. For each segment, an incentive provider can select one or more qualifications that a consumer user must meet in order to be classified in a segment. A GUI such as the one illustrated in FIG. 4E can be used for this purpose. Examples of qualifications (selectable in FIG. 4E via drop down menu “Add Qualifications”) include, but are not limited to, marital status, income, number of children, investment activity, recreational interests, credit worthiness, travel frequency, state and/or country of residence, gender, or any other metric that a consumer user may identify during the registration process or over time. For example, an incentive provider may create a “soccer mom” segment to target women from the Midwest between the ages of 30-50 with one or more children. Thus, the segment feature of the incentive access system 200 enables incentive providers to create a variety of segments that may be applied to incentives in order to target specifically consumer users meeting the criteria of the segment. A consumer user that meets the minimum qualifications for a segment is referred to as “lead.” The requirements or qualifications for each incentive may be stored in incentive database 206.

As can be seen in FIG. 4E, the segment “Golf” is associated with a number of “qualifications” that are listed for that segment. The qualifications of interest for this segment, as defined by the service provider, include Age, Marital Status, Number of Children, Income, Housing, State/Region and Home Ownership. The qualifications also list the percentage of registered consumer users at that time that meet that particular qualification parameter.

FIG. 4F illustrates one example of a GUI that enables an incentive provider user to view each of the predefined segments as well as the qualifications for each of the segments that are associated with an incentive provider account. Selecting on “edit” for a segment brings up a GUI similar to that shown in FIG. 4E to allow for editing of the qualifications/criteria defined for a segment. Selecting on “view qualifications” for a segment brings up a GUI such as that shown in FIG. 4G, which lists the qualifications for the segment. FIG. 4F also displays, for each segment, the number of “Active Incentives” (i.e., the number of active incentives having that segment as a pre-qualification), “Member Match” (i.e., the percentage of registered customer users that fall within that segment, and “Leads” (i.e., the number of leads generated from incentive deals having that segment as a pre-qualification). The pie chart icon permits the service provider user to access functionality for generating reports.

A variety of incentives may be offered through the incentive access system 200. For example, a free or reduced night stay at a particular property may be provided, a free or reduced priced trip or tour, free or reduced price tickets to an entertainment event, a gift certificate to a restaurant, free merchandise, or other incentives may be provided. Other example incentives include, but are not limited to, free or reduced airfare and free or reduced price car rentals. A description of the incentive along with a legal disclaimer including the terms of eligibility and the requirements for acquiring the incentive deal being offered should be provided by the incentive provider. An incentive provider user may also provide start and end dates defining a period during which the incentive will be offered. Numerous other user-fillable fields may also be provided depending on the type of incentive. For example, if the incentive is a free or reduced price stay at a hotel, fields may be provided for the incentive user to identify the number of days and nights, the type of room, and the maximum number of occupants per room for which the incentive is offered. The data for each incentive is stored in incentive database 206.

Incentive access system 200 may enable each incentive provider user to review each existing incentive associated with the incentive provider through a GUI such as the one illustrated in FIG. 4H. As shown in FIG. 4H, the GUI may display active incentives (e.g., incentives deals that are currently being offered by the incentive provider), scheduled or upcoming incentives (e.g., incentives deals that are going to be offered in the future), and inactive or expired incentives (e.g., incentive deals that are no longer being offered by the incentive provider, but may have been offered in the past). The GUI illustrated in FIG. 4H also enables incentive provider users to readily identify the start and end dates for each incentive deal as well as which segments are targeted for each incentive deal and the leads for each incentive. An incentive provider user can make a particular incentive active or inactive as well as edit the properties for each incentive through the interface of FIG. 4H.

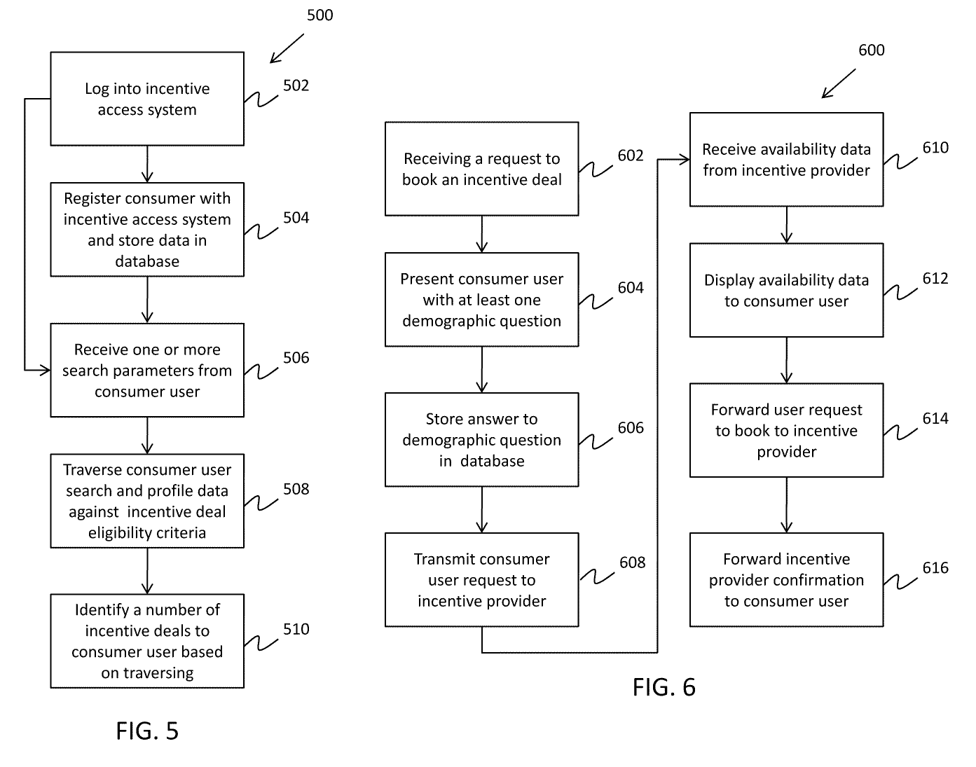

Incentive access system 200 provides consumer users with the ability to search for one or more incentive deals offered by incentive providers based on a number of criteria. FIG. 5 is a flow diagram illustrating one example of a method of searching performed by incentive access system 200. As shown in FIG. 5, a consumer user logs into the incentive access system 200 at block 502. If the consumer user is not registered with the incentive access system, then the consumer user is required to register with the incentive access system 200 at block 504. As described above, the consumer user may be required to identify at least one demographic criterion, e.g., gender, education, household income, occupation, religion, marital status, number of children, housing type, home value, length of residence, or the like to create a profile for the consumer user to be stored in a data storage device 204. If the consumer user was already registered, then he or she enters his or her username and password at block 502 and proceeds to block 506.

At block 506, the consumer user enters one or more search terms into the incentive access system 200. For example, a consumer user may be able to search for incentives based on multiple criteria including, but not limited to, resort location, incentive category (e.g., vacations, dining out, entertainment, trips/tours, automobile rental, airfare, merchandise, or the like), and theme (e.g., golf/tennis, family fun, romance, beach, relaxation, lake, mountain, snow, weekend, history, honeymoons, arts and culture, cruise, casino, or the like). FIG. 2B illustrates one example of a GUI that may be provided by incentive access system 200 for a consumer user to search for an incentive deal after the consumer logs into the system.

Once the consumer user selects the criteria for the search, incentive access system 200 searches the incentive database 206 and retrieves stored incentives that match the criteria entered by the consumer user at block 508. Preferably, the system 200 traverses not only the consumer's search criteria against incentive data in database 206 but all the consumer's profile data against the segments associated with the incentive deals. In this manner, the system 200 retrieves from incentive database 206 only the stored incentives that not only match the criteria entered by the consumer user, but also that have segments or qualifications for which the consumer user matches or exceeds based on the consumer user's profile. For example, the incentive access system 200 may only retrieve incentive deals that require a minimum credit score of 600 if the consumer user's profile indentifies the consumer user as having a credit score of 620, but will not retrieve incentive deals requiring credit scores of greater than 620. By way of another example, incentive deals for properties tailored for families will not be retrieved for a consumer user identified as a “single male” or “single female.” In this manner, incentive access system 200 enables incentive providers to target particular segments of consumer users.

At block 510, the incentive access system 200 presents the results of the search to the consumer user. The results of the search are displayed to the consumer user such that the consumer user can browse the list of results, which may also include an image, title, availability, valued-at price, and brief synopsis of the deal. One example of a GUI displaying the results of a search to a consumer user is illustrated in FIG. 2C. As can be seen in FIG. 2C, the user can further define his or her search using the “Modify Your Search” option. The user can also organize the search using the “Sort by” option, which reorders the search results by either retail value of the trip or by the availability date.

The consumer user may review the one or more incentive deals returned by the search by selecting the one or more incentive deals, e.g., by using an input device such as a keyboard or mouse, which will bring the consumer user to a GUI that provides more details concerning the incentive deal. For example, a consumer user may be able to read descriptions about, and the requirements for, the incentive deal as well as check availability, view images and/or videos of the property or merchandise offered, and book the incentive deal. One example of a GUI providing information concerning an incentive deal selected by a consumer user is illustrated in FIG. 2D. As shown in FIG. 2E, information of interest on the deal may included Deal Details information, What to Expect information, How it Works information and Terms information. The consumer user may also book the incentive deal using the incentive access system 200.

FIG. 6 is a flow diagram of one example of a method of booking an incentive deal through the incentive access system 200. When the consumer user has decided for which incentive deal he or she would like to register, the consumer user may click on the desired incentive deal and select the number of adults and children that will be attending, the date and/or time desired, and submit a request to book the incentive deal through incentive access system 200 at block 602. At block 604, the incentive access system 200 may display a question concerning the demography of the consumer user upon receiving the request to book the incentive deal. Once the consumer user submits an answer to the question, the incentive access system 200 may store the answer in the consumer database 204 at block 606, thereby updating the consumer's profile. In this manner, incentive access system 200 may continue to develop the profile of each consumer user even after the initial registration.

At block 608, the incentive access system 200 transmits the consumer user's request to the incentive provider to check availability of the incentive deal for the date or time requested by the consumer user. In some embodiments, incentive access system 200 interfaces with a booking system provided by an incentive provider, e.g., a hotel provider website, to check availability of the incentive deal in real time. In some embodiments, incentive access system 200 transmits the request received from the consumer user to the incentive provider and the incentive provider handles the booking process.

The incentive access system 200 may receive a response from the incentive provider concerning the availability of the incentive deal requested by the consumer user, which may be displayed to the consumer user on a display device such as a monitor by the incentive access system 200 at block 612. If the incentive deal is not available during the date or time requested, then the incentive access system 200 may display other dates and times from which the consumer user may make a selection. If the incentive deal is available during the date and time requested, then the consumer user may be prompted to confirm that he or she has read and agrees to the terms and conditions associated with the incentive deal. For example, the terms and conditions may also include an itinerary of the incentive deal that identifies how long the one or more sales presentations that the consumer user must attend in order to receive the incentive deal may last. The consumer user may agree to the terms and conditions as well as confirm the incentive deal, or the consumer user may choose not to confirm the incentive deal.

At block 614, the incentive provider forwards the consumer user's confirmation to the incentive deal provider should the consumer user choose to accept the terms and conditions and confirm the incentive deal. Upon receiving the confirmation from the incentive access system 200, the incentive deal provider may respond with its own confirmation, which triggers the incentive access system 200 to transmit a final confirmation message to the consumer user at block 616. The confirmation message generated by the incentive access system may be in the form of an email, text message, or like notification as a confirmation. A confirmation message may also be sent to a personal message center that may be provided by the incentive access system 200.

The consumer user may also be able to view and read the biographies of the sales representatives that will be giving presentations at the property where the incentive deal has been booked. Additionally, the consumer user may choose a preference of one of the representatives, request a call from the sales representatives prior to the incentive deal, or continue using the incentive access system 200 to search for other incentive deals.

In addition to searching for posted incentive deals, consumer users may be able to send a request for an incentive deal to an incentive provider. In some embodiments, consumer users may be provided with a user-fillable field in which they may describe the proposed incentive deal. The proposed incentive deal may be transmitted to one or more incentive providers that have elected to receive incentive deal requests, such as my opting into the “Buy My Time” feature noted in FIG. 4C. The one or more incentive providers may review the proposed incentive deal and determine if they will accept the proposed incentive deal. The decision of the one or more incentive providers may be transmitted to the consumer user in the form of an email, text message, or in a message sent to the personal message center of the consumer user that may be provided by the incentive access system 200. Other types of notification messages may also be provided or transmitted by incentive access system 200.

Incentive access system 200 may also provide consumer users with the ability to view past and upcoming incentive deals as well as the ability to watch for upcoming deals. For example, a consumer user may be able to set an alert for new incentive deals in a particular geographic location, during a specific time frame, or having any number of other criteria as described above with respect to incentive deal searching. The incentive access system 200 may store the watch lists for each of the consumer user and may cross-reference new incentive deals against these watch lists each time an incentive deal is added by an incentive provider or periodically in a batch mode.

When an incentive provider user logs onto the incentive access system 200, the user may be able to add, change, or delete properties or products associated with the incentive provider as well as add, change, or delete incentive deals offered by the incentive provider. Incentive access system 200 may also enable incentive provider users to view their leads. For example, a list of new leads (e.g., newly registered consumer users who meet the minimum criteria for a segment), leads awaiting confirmation (e.g., consumer users who meet the minimum criteria for a segment and have requested an incentive deal), confirmed leads (e.g., consumer users who meet the minimum criteria for a segment, have requested an incentive deal, and have been confirmed for an incentive deal), and past leads for each property and/or incentive offered by the incentive provider. Incentive provider users may also be able to review the member profile for each lead as well as any ratings and/or reviews that the lead has submitted for other resorts.

Incentive provider users may also have the ability to create and modify biographies for each of the sales representatives that are associated with each property of the incentive provider. For example, an incentive provider user may provide the name and title of the sales representative as well as upload one or more photographs of the representative.

The incentive access system 200 may be configured to compute a variety of statistics and provide these statistics to incentive provider users. For example, incentive access system 200 may compute the average consumer user rating for each of the properties associated with an incentive provider. Additional statistics may be developed for each property that provide incentive provider users with a finer resolution of consumer user satisfaction of an incentive or property that may be based on one or more of the metrics, e.g., income, age, sex, marital status, or the like. Such statistics may be based on data received from consumer users, externally derived data (e.g., credit reports, background checks, or the like) as well as internally derived data (e.g., customer prospect behavior as to what types of incentives and/or properties are viewed).

Incentive access system 200 may provide incentive provider users the ability to generate customized reports based on certain periods of time as well as data received and/or derived from consumer users that is stored in consumer database 204. Some predefined reports may be provided by incentive access system 200 including, but not limited to, reports on the total number of visits to each and all incentive deals, total number of leads to each and all incentives, the conversion rate for each and all incentives, number of sales for each and all incentives, and sales conversion rate for each and all incentives.

Incentive access system 200 may also provide incentive provider users the ability to select one or more incentive deals that will be featured to consumer users by the incentive access system 200. Featured incentive deals are displayed to consumer users without the consumer users having to search for the featured incentive deal, e.g., in an advertisement, thereby ensuring incentive providers that their deals will be viewed by leads. For example, incentive provider users may have the option to make an incentive deal a featured incentive deal at the time the incentive user creates the incentive deal, or an incentive provider user may make an existing incentive deal (e.g., an incentive deal that has already been created and stored in incentive database 206) a featured deal by selecting the existing incentive deal from a list of incentive deals. In some embodiments, the incentive access system 200 may require a payment for a predetermined number of impressions (e.g., number of times a featured incentive deal will be advertised by incentive access system 200). These featured incentive deals may be presented to leads for the incentive deal when the consumer users log onto the incentive access system 200, or as part of search results or search interface (See, e.g., FIG. 2B (“Smokin' Hot Deals”)) or the featured incentive deal may be sent to leads as an email, a text message, or a message may be sent to the personal message center of the consumer user provided by the incentive access system 200. If a featured deal is automatically displayed to a customer after customer log in, such as in FIG. 2B, the featured is displayed only if the customer satisfies the customer profile requirements associated with the featured deal.

Additionally, incentive provider users may be able to access real-time reports concerning the featured incentive deals. Examples of such reports include, but are not limited to, campaign delivery reports, an advertising analysis report, and a campaign analysis report. Each of these reports may identify a click-through rate (CTR) for each featured incentive deal, a cost per impression (CPI) for each featured incentive deal, or other like e-marketing metrics for each featured impression.

The present invention can be embodied in the form of methods and apparatus for practicing those methods. The present invention can also be embodied in the form of program code embodied in tangible media, such as floppy diskettes, CD-ROMs, DVD-ROMs, blu-ray disks, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

Although the invention has been described in terms of exemplary embodiments, it is not limited thereto. Rather, the appended claims should be construed broadly to include other variants and embodiments of the invention that may be made by those skilled in the art without departing from the scope and range of equivalents of the invention.

What is claimed is:

1. A computer-implemented method of providing customers access to incentive deals, comprising:
maintaining a database of customer prospect accounts associated with customer prospects in a computer readable storage medium, each of the customer prospect accounts including customer data associated with the customer prospect;
registering a plurality of incentive deals in an incentive deal database stored in the computer readable storage medium, each incentive deal being associated with incentive deal identifying data and predetermined customer prospect eligibility criteria;
traversing the customer data against the predetermined customer prospect eligibility criteria; and
based on results of the traversing step, causing identification to the customer prospect on a user terminal a description of one or more incentive deals from the plurality of incentive deals for which the customer prospect is eligible.

2. The method of claim 1, further comprising:
enabling the customer prospect to enter search criteria for an incentive deal; and
traversing entered search criteria against the incentive deal identifying data,
wherein incentive deal identifying data for the one or more incentive deals identified to the customer prospect match the search criteria.

3. The method of claim 2, wherein the search criteria comprise incentive type, incentive location, and incentive date.

4. The method of claim 1, wherein the customer data includes customer prospect income data, customer prospect age data, customer prospect credit card ownership status data, customer prospect residence arrangement status data, or a combination thereof

5. The method of claim 1, wherein the incentive deals are free to the customer prospect and include deals from one or more of the following incentive categories: vacations, entertainment, merchandise, dining, trips, and tours.

6. The method of claim 1, further comprising maintaining a plurality of incentive deal provider accounts in an incentive deal provider account database, the incentive deal provider account database stored in a computer-readable storage medium.

7. The method of claim 6, wherein each incentive deal provider account enables an incentive deal provider to register incentive deals for presentation to customer contacts and record incentive deal identifying data and predetermined customer prospect eligibility criteria for the registered incentive deals.

8. The method of claim 7, further comprising:
tracking customer prospect leads for each registered incentive deal;
tracking bookings for the registered incentive deals; and
generating a report of the leads and bookings.

9. The method of claim 1, further comprising:
causing display on the user terminal of an interface for enabling the customer prospect to initiate booking of an incentive deal identified to the customer prospect.

10. The method of claim 9, further comprising:
receiving an initiation of a booking of an incentive deal from a customer prospect;
obtaining from the customer prospect at least one additional piece of customer data; and
recording the at least one additional piece of customer data in the customer prospect account associated with the customer prospect, whereby a customer profile for the customer prospect is built over time with each booking by the customer prospect.

11. The method of claim 9, further comprising:
receiving customer data for a customer prospect;
verifying at least a portion of the customer data for accuracy against an independent data source; and
if the portion of customer data is verified, permitting the customer prospect to initiate the booking

12. The method of claim 9, wherein the incentive deal involves an agreement by the customer prospect to attend a sales presentation, the method further comprising the step of providing a description of the customer prospect's obligations with respect to the sales presentation for consideration before booking

13. The method of claim 1, wherein the plurality of incentive deals are compiled from a plurality of different incentive deal providers.

14. A computer implemented system for providing customers access to incentive deals, comprising:
a computer readable storage medium for maintaining a database of customer prospect accounts associated with customer prospects, each of the customer prospect accounts including customer data associated with the customer prospect; and
a processor in data communication with the computer readable storage medium, the processor configured to:
register a plurality of incentive deals in an incentive deal database in the computer readable storage medium, each incentive deal being associated with incentive deal identifying data and predetermined customer prospect eligibility criteria;
traverse the customer data against the predetermined customer prospect eligibility criteria; and
based on results of the traversing, cause a description of one or more incentive deals from the plurality of incentive deals for which the customer prospect is eligible to be identified to the customer prospect on a user terminal.

15. The computer implemented system of claim 14, wherein the processor is configured to:
enable the customer prospect to enter search criteria for an incentive deal; and
traverse entered search criteria against the incentive deal identifying data,
wherein incentive deal identifying data for the one or more incentive deals identified to the customer prospect match the search criteria.

16. The computer implemented system of claim 15, wherein the search criteria comprise incentive type, incentive location, and incentive date.

17. The computer implemented system of claim 14, wherein the customer data includes customer prospect income data, customer prospect age data, customer prospect credit card ownership status data, customer prospect residence arrangement status data, or a combination thereof

18. The computer implemented system of claim 14, wherein the incentive deals are free to the customer prospect and include deals from one or more of the following incentive categories: vacations, entertainment, merchandise, dining, trips, and tours.

19. The computer implemented system of claim 14, wherein the processor is configured to maintain a plurality of incentive deal provider accounts in an incentive deal provider account database, the incentive deal provider account database stored in the computer-readable storage medium.

20. The computer implemented system of claim 19, wherein each incentive deal provider account enables an incentive deal provider to register incentive deals for presentation to customer contacts and record incentive deal identifying data and predetermined customer prospect eligibility criteria for the registered incentive deals.

21. The computer implemented system of claim 20, wherein the processor is configured to:
track customer prospect leads for each registered incentive deal;
track bookings for the registered incentive deals; and
generate a report of the leads and bookings

22. The computer implemented system of claim 14, wherein the processor is configured to cause an interface for enabling the customer prospect to initiate booking of an incentive deal identified to the customer prospect to be displayed on the user terminal.

23. The computer implemented system of claim 22, wherein the processor is configured to:
receive an initiation of a booking of an incentive deal from a customer prospect;
obtain from the customer prospect at least one additional piece of customer data; and
record the at least one additional piece of customer data in the customer prospect account associated with the customer prospect in the computer readable storage medium, whereby a customer profile for the customer prospect is built over time with each booking by the customer prospect.

24. The computer implemented system of claim 22, wherein the processor is configured to:
receive customer data for a customer prospect;
verify at least a portion of the customer data for accuracy against an independent data source; and
if the portion of customer data is verified, permit the customer prospect to initiate the booking

25. A computer-implemented method of providing potential customers access to incentive deals, the method comprising:
displaying a first graphical user interface (GUI) on a first user terminal to a potential customer, the first GUI requesting the potential customer to enter customer data including customer identification data and customer demographic data;
storing the customer data received from the potential customer in a customer database such that it is associated with an account for the potential customer;
displaying a second GUI on a second user terminal to an incentive provider user, the second GUI requesting the incentive provider user to enter incentive deal data, the incentive deal data including incentive deal description data and incentive deal eligibility data;
storing the incentive deal data received from the incentive provider user in an incentive database such that it is associated with an account for an incentive deal provider, the incentive database including incentive deal data for a plurality of incentive deals;
receiving a search request including search criteria from the potential customer;
searching the incentive database to identify an incentive deal that matches the search criteria entered by the potential customer and for which the potential customer is eligible in response to receiving the search request, wherein eligibility of the potential customer is based on matching the customer demographic data with the incentive deal eligibility data; and
displaying a third GUI to the potential customer, the third GUI including a result of the search.

26. The computer-implemented method of claim 25, further comprising:
in response to a request from the potential customer to book an incentive deal identified in the result of the search,
requesting the potential customer provide additional customer demographic data in response to the request to book the incentive deal; and
storing the additional customer demographic data in the customer database such that it is associated with the account of the potential customer.

27. The computer-implemented method of claim 25, wherein the customer demographic data includes customer prospect income data, customer prospect age data, customer prospect credit card ownership status data, customer prospect residence arrangement status data, or a combination thereof.
